(19) United States
(12) Patent Application Publication
(10) Pub. No.: US 2008/0312081 A1
(43) Pub. Date: Dec. 18, 2008

(54) Method for Control of Ground Shoots of Vines and Other Trunk Vegetation

(75) Inventors: Jean LeBlanc, Amberieux d'Azergues (FR); Michel Sarazin, Ecully (FR)

Correspondence Address: John M. Sheehan;FMC Corporation, 1735 Market Street, Philadelphia, PA, 19103, US

(73) Assignee: FMC CORPORATION, Philadelphia, PA (US)

(21) Appl. No.: 10/588,915

(22) PCT Filed: Feb. 9, 2005
(86) PCT No.: PCT/US05/04353

§ 371 Date: Sep. 2, 2008

Related U.S. Application Data
(60) Provisional application No. 60/543,348, filed on Feb. 10, 2004.

(51) Int. Cl. A01N 59/20; A01N 43/653; A01P 21/00

(52) U.S. Cl. 504/121; 504/273

(57) ABSTRACT

Protoporphyrinogen oxidase enzyme-inhibiting herbicides are useful in a method for controlling unwanted ground shoots of vines and other trunk vegetation. Of particular interest is the use of carfentrazone ethyl and certain metabolites thereof for control of unwanted ground shoots of vines and other trunk vegetation.

This application claims the benefit of U.S. Provisional Application No. 60/543,348, filed Feb. 10, 2004.

### FIELD OF THE INVENTION

The present invention relates to the field of controlling unwanted ground shoots of vines and other trunk vegetation.

### BACKGROUND OF THE INVENTION

Unwanted ground shoots grow at the base of the main trunk of vines and other trunk vegetation impeding the growth of the main trunk by using available nutrients. In order to have a strong, healthy main trunk, the unwanted ground shoots must be removed. Physical removal, chemical treatment or combinations of both are generally used to achieve control of these unwanted ground shoots.

Physical removal is expensive and time consuming. The actual physical removal of the ground shoot exposes a wound in the trunk vine or other trunk vegetation. The exposed wound allows disease entry that adversely affects growth or kills the vine or vegetation. Hence, physical removal is not optimal.

Chemical treatment of unwanted ground shoots requires the application of a chemical, i.e., a herbicide, to the area where the ground shoots are located. Herbicides known for use to control ground shoots are diquat and paraquat. There are considerable shortcomings in using the aforementioned herbicides for controlling ground shoots. For example, these herbicides have unfavorable worker safety ratings (they are classified T/T+ in toxicity), they are very slow acting, require high application rates and, in some instances, they cause a wound that allows disease entry.

Clearly, chemical methods of treatment are lacking in some respects for the control of unwanted ground shoots with the herbicides presently being used.

A newer class of herbicides different than those set forth above controls plants by disrupting certain functions in the plant cell. These herbicides are known as inhibitors of the enzyme protoporphyrinogen oxidase (commonly known as PPO-inhibitors), which cause disruption of cell membranes by inducing lipid peroxidation resulting in death to the plant. An example of an herbicidal PPO-inhibitor is carfentrazone-ethyl:

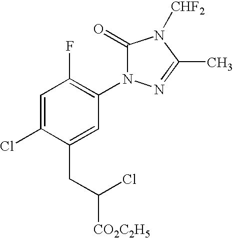

Carfentrazone-ethyl, namely ethyl α,2-dichloro-5-[4-(difluoromethyl)-4,5-dihydro-3-methyl-5-oxo-1H-1,2,4-triazol-1-yl]-4-fluorobenzenepropanoate, is disclosed and claimed in U.S. Pat. No. 5,125,958.

### SUMMARY OF THE INVENTION

It has been found that the use of PPO-inhibitors on unwanted grounds shoots of vines and other trunk vegetation effectively and quickly kills the ground shoot at low use rates. Also, as the shoot falls off, an abscission layer remains where the base of the shoot was attached to the main trunk. This abscission layer forms an effective barrier to disease entry. The aforementioned herbicides previously used for controlling ground shoots do not allow an abscission layer to form.

In accordance with the present invention, it has now been found that protoporphyrinogen oxidase enzyme-inhibiting (PPO-inhibiting) herbicides are useful in controlling unwanted ground shoots of vines and other trunk vegetation. Specifically, the invention relates to a method for controlling unwanted ground shoots of vines and other trunk vegetation, which comprises applying an effective amount of a protoporphyrinogen oxidase enzyme-inhibiting herbicide to a locus where said ground shoots are growing. Other aspects of the present invention will become apparent from the description below.

### DETAILED DESCRIPTION OF THE INVENTION

One aspect of the present invention relates to a method for controlling unwanted ground shoots of vines and other trunk vegetation, which comprises applying an effective amount of a protoporphyrinogen oxidase enzyme-inhibiting herbicide to a locus where said ground shoots are growing. Other trunk vegetation can include, but is not limited to, top fruit (apple, pear and others), stone fruit (peach, plum, cherry, nectarine and others), soft fruits (raspberry, blackberry, gooseberry, strawberry and others), citrus (orange, lemon, mandarin and others), hops, trees, bushes, rootstock vegetation, bushy vegetation and Amenity. A preferred embodiment of the invention is that wherein said unwanted ground shoots of vines and other trunk vegetation are vine ground shoots and stone fruit tree ground shoots. Preferred stone fruit tree ground shoots are plum tree ground shoots.

As set forth above, PPO-inhibiting herbicides, their agriculturally-acceptable salts, esters, acids, and metabolites find utility in controlling unwanted ground shoots of vines and other trunk vegetation when applied by the methods of the present invention to a locus where said ground shoots are growing. Examples of such PPO-inhibiting herbicides include, without limitation, one or more of acifluorfen-sodium, aclonifen, bifenox, chlomethoxyfen, chlornitrofen, ethoxyfen-ethyl, fluorodifen, fluoroglycofen-ethyl, fluoronitrofen, fomesafen, furyloxyfen, halosafen, lactofen, nitrofen, nitrofluorfen, oxyfluorofen, cinidon-ethyl, flumiclorac-pentyl, flumioxazin, profluazol, pyrazogyl, oxadiargyl, oxadiazon, pentoxazone, fluazolate, pyraflufen-ethyl, benzfendizone, butafenacil, fluthiacet-methyl, thidiazimin, azafenidin, carfentrazone ethyl, sulfentrazone, flufenpyr-ethyl, as well as other PPO-inhibiting herbicides, and their agriculturally-acceptable salts, esters, acids, and metabolites. A preferred PPO-inhibiting herbicide for control of unwanted ground shoots of vines and other trunk vegetation is carfentrazone ethyl and the metabolites of carfentrazone ethyl, namely, i) α,2-dichloro-5-[4-(difluoromethyl)-4,5-dihydro-3-methyl-5-oxo-1H-1,2,4-triazol-1-yl]-4-fluorobenzenepropanoic acid (chloropropanoic acid), ii) 2-dichloro-5-[4-(difluoromethyl)-4,5-dihydro-3-methyl-5-oxo-1H-1,2,4-triazol-1-yl]-4-fluorobenzenepropenoic acid (cinnamic acid), iii) 2-dichloro-5-[4-(difluoromethyl)-4,5-dihydro-3-methyl-5-oxo-1H-1,2,4-triazol-1-yl]-4-fluorobenzoic acid (benzoic acid), and iv) 2-chloro-5-[4-(difluoromethyl)-4,5-dihydro-3-methyl-5-oxo-1H-1,2,4-triazol-1-yl]-4-fluorobenzenepropanoic acid (propanoic acid). A more preferred PPO-inhibiting herbicide for control of unwanted ground shoots of vines and other trunk vegetation is carfentrazone ethyl.

Other analogs, homologs or derivatives of carfentrazone ethyl that find utility in the methods of the present invention include the following:

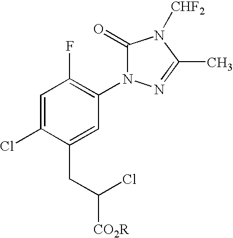

where R is selected from CH₃, CH₂CH₂CH₃, CH(CH₃)₂, (CH₂)₃CH₃, CH₂CH(CH₃)₂, n-pentyl, n-hexyl, Na⁺, K⁺, Li⁺, Ca⁺, and NH₄⁺.

Carfentrazone ethyl, the metabolites, the analogs, homologs or derivatives set forth herein may be prepared by the methods taught in U.S. Pat. No. 5,125,958 or by methods analogous thereto, or by methods known to one skilled in the art.

Carfentrazone ethyl can be used at an application rate or concentration of from about 12 g/hl to about 36 g/hl. Preferrably, carfentrazone ethyl can be used at an application rate or concentration of about 18 g/hl.

Under certain conditions it may be advantageous in the control of unwanted ground shoots of vines and other trunk vegetation to combine an effective amount of one or more of the PPO-inhibiting herbicides with a second herbicide. Of particular advantage is the combination of one or more other herbicides that are known to have herbicidal activity on unwanted ground shoots of vines and other trunk vegetation or are known for other uses, such as diquat, paraquat, copper sulfate, copper chelates, endothall, 2,4-D, fluridone, glufosinate-ammonium, glyphosate, imazapyr, fluridone, triclopyr, clomazone, and bensulfuron. A preferable combination of a PPO-inhibiting herbicide and a herbicide known for activity on unwanted ground shoots of vines and other trunk vegetation is carfentrazone ethyl and one or more of diquat, paraquat, copper sulfate, copper chelates, endothall, 2,4-D, fluridone, glufosinate-ammonium, glyphosate, imazapyr, fluridone, triclopyr, clomazone, and bensulfuron.

As used in this specification and unless otherwise indicated the terms “protoporphyrinogen oxidase enzyme-inhibiting”, “protoporphyrinogen oxidase enzyme-inhibitor”, “PPO-inhibiting”, or “PPO-inhibitor” as these terms relate to the herbicides used in the present invention are one and the same. The term “controlling” refers to the killing of, or minimizing the amount of unwanted vine and other trunk vegetation ground shoots to a point where they no longer poses a threat the main trunk vine or vegetation. The term “l/hl” refers to liters per hectoliter. The term “g/hl” refers to grams per hectoliter. The term “hectoliter” refers to 100 liters of spray volume.

The modifier “about” is used herein to indicate that certain preferred ranges are not fixedly determined. The meaning will often be apparent to one of ordinary skill. Where guidance from the experience of those of ordinary skill is lacking, guidance from the context is lacking, and where a more specific rule is not recited below, the “about” range shall be not more than 10% of the absolute value of an end point or 10% of the range recited, whichever is less.

One skilled in the art will, or course, recognize that the formulation and mode of application of a toxicant may affect the activity of the material in a given application. Thus, for use in the control of unwanted ground shoots of vines and other trunk vegetation, the PPO-inhibiting herbicides finding utility in the present invention may be formulated as granules of relatively large particle size, as water-soluble or water-dispersible granules, as powdery dusts, as wettable powders, as emulsifiable concentrates, as solutions, or as any of several other known types of formulations, depending on the desired mode of application. It is to be understood that the amounts specified in this specification are intended to be approximate only, as if the word “about” were placed in front of the amounts specified.

These herbicidal compositions may be applied either as water-diluted sprays, or dusts, or granules to the areas in which suppression of vegetation is desired. These formulations may contain as little as 0.1%, 0.2% or 0.5% to as much as 95% or more by weight of active ingredient.

Dusts are free flowing admixtures of the active ingredient with finely divided solids such as talc, natural clays, kieselguhr, flours such as walnut shell and cottonseed flours, and other organic and inorganic solids which act as dispersants and carriers for the toxicant; these finely divided solids have an average particle size of less than about 50 microns. A typical dust formulation useful herein is one containing 1.0 part or less of the herbicidal compound and 99.0 parts of talc.

Wettable powders are in the form of finely divided particles, which disperse readily in water or other dispersant. The wettable powder is ultimately applied either as a dry dust or as an emulsion in water or other liquid. Typical carriers for wettable powders include Fuller's earth, kaolin clays, silicas, and other highly absorbent, readily wet inorganic diluents. Wettable powders normally are prepared to contain about 5-80% of active ingredient, depending on the absorbency of the carrier, and usually also contain a small amount of a wetting, dispersing or emulsifying agent to facilitate dispersion. For example, a useful wettable powder formulation contains 80.0 parts of the herbicidal compound, 17.9 parts of Palmetto clay, and 1.0 part of sodium lignosulfonate and 0.3 part of sulfonated aliphatic polyester as wetting agents.

Other useful formulations for herbicidal applications are emulsifiable concentrates (ECs) which are homogeneous liquid compositions dispersible in water or other dispersant, and may consist entirely of the herbicidal compound and a liquid or solid emulsifying agent, or may also contain a liquid carrier, such as xylene, heavy aromatic naphthas, isphorone, or other non-volatile organic solvents. For herbicidal application these concentrates are dispersed in water or other liquid carrier and normally applied as a spray to the area to be treated. The percentage by weight of the essential active ingredient may vary according to the manner in which the composition is to be applied, but in general comprises 0.5 to 95% of active ingredient by weight of the herbicidal composition.

Flowable formulations are similar to ECs except that the active ingredient is suspended in a liquid carrier, generally water. Flowables, like ECs, may include a small amount of a surfactant, and will typically contain active ingredients in the range of 0.5 to 95%, frequently from 10 to 50%, by weight of the composition. For application, flowables may be diluted in water or other liquid vehicle, and are normally applied as a spray to the area to be treated.

Typical wetting, dispersing or emulsifying agents used in certain formulations include, but are not limited to, the alkyl and alkylaryl sulfonates and sulfates and their sodium salts; alkylaryl polyether alcohols; sulfated higher alcohols; polyethylene oxides; sulfonated animal and vegetable oils; sulfonated petroleum oils; fatty acid esters of polyhydric alcohols and the ethylene oxide addition products of such esters; and the addition product of long chain mercaptans and ethylene oxide. Many other types of useful surface-active agents are available in commerce. Surface-active agents, when used, normally comprise 1 to 15% by weight of the composition.

Still other useful formulations for herbicidal applications include simple solutions of the active ingredient in a solvent in which it is completely soluble at the desired concentration, such as acetone, alkylated naphthalenes, xylene, or other organic solvents. Granular formulations, wherein the toxicant is carried on relative coarse particles, are of particular utility for aerial distribution or for penetration of a cover canopy. Pressurized sprays, typically aerosols wherein the active ingredient is dispersed in finely divided form as a result of vaporization of a low-boiling dispersant solvent carrier may also be used. Water-soluble or water-dispersible granules are free-flowing, non-dusty, and readily water-soluble or water-miscible. In use by the farmer on the field, the granular formulations, emulsifiable concentrates, flowable concentrates, solutions, etc., may be diluted with water to give a concentration of active ingredient in the range of say 0.1% or 0.2% to 1.5% or 2%.

The following examples further illustrate the present invention, but, of course, should not be construed as in any way limiting its scope. The examples are organized to present protocols for the evaluation of certain PPO-inhibiting herbicides when placed in contact with unwanted ground shoots of vines and other trunk vegetation, and set forth certain biological data indicating the efficacy of such compounds.

### EXAMPLE 1

### Efficacy Test of Carfentrazone-ethyl on Unwanted Vine Ground Shoots

Trials were conducted by spraying 12-36 g/hl of carfentrazone formulated as a 60 ME (equivalent to 0.2-0.6 l/hl of SPOTLIGHT PLUS 60 ME, a composition containing 60 g/l carfentrazone) onto the vine shoots. The vines were evaluated periodically after application. Percent (%) control or efficacy was determined as a percentage by volume reduction of the vine shoots after spraying compared to an untreated reference. Four trials were conducted.

The results, shown as an average of the four trials, are compared with results observed in the same trials with diquat (Reglone 2) applied at 1.0 litre/hl and paraquat (Gramoxone Plus) at 1.4 l/hl. The results and comparison are in Table 1 below.

TABLE 1

% Efficacy

| | Rate | DAT | DAT | DAT | DAT |
|---|---|---|---|---|---|
| | l/hl | 3 | 7 | 14 | 30 |
| Spotlight Plus | 0.2 | 97.5 | 98 | 96.7 | 91.2 |
| 60ME | | | | | |
| Spotlight Plus | 0.3 | 97.6 | 99 | 97.5 | 87.6 |
| 60ME | | | | | |
| Spotlight Plus | 0.4 | 98.3 | 98.0 | 98.4 | 85.5 |
| 60ME | | | | | |
| Spotlight Plus | 0.6 | 97.9 | 99.0 | 98.8 | 87.0 |
| 60ME | | | | | |
| Reglone 2 | 1.0 | 76.0 | 66.4 | 79.5 | 84.6 |
| Gramoxome | 1.4 | 83.5 | 76 | 85.1 | 84.3 |
| Plus | | | | | |
| Check | 0 | 0 | 0 | 0 | 0 |

DAT = Days after treatment

### EXAMPLE 2

### Efficacy Test of Carfentrazone-ethyl on Unwanted Vine Ground Shoots with Second Application

Trials were conducted by spraying 12-18 g/hl carfentrazone formulated as a 60 ME (equivalent to 0.2-0.3 l/hl of SPOTLIGHT PLUS 60 ME containing 60 g/l carfentrazone) onto the vine shoots. A second application was applied after 30 days. The vines were evaluated periodically after application of the second spray. Percent (%) control or efficacy was determined as a percentage by volume reduction of the vine shoots after spraying compared to an untreated reference. Four trials were conducted

The results, shown as an average of the four trials, are compared with results observed in the same trials with diquat (Reglone 2) applied at 2×1.0/hl and paraquat (Gramoxone Plus) at 2×1.4 l/hl at 30 days interval respectively. The results and comparison are in Table 2 below.

TABLE 2

| | | % Efficacy | | |
|---|---|---|---|---|
| | Rate | DAST | DAST | DAST |
| | l/hl | 7 | 14 | 30 |
| Spotlight Plus | 0.2 | 96.1 | 95.1 | 95.9 |
| 60ME | | | | |
| Spotlight Plus | 0.3 | 99 | 98.8 | 99 |
| 60ME | | | | |
| Reglone 2 | 1.0 | 89.4 | 92.8 | 95.3 |
| Gramoxome | 1.4 | 94.0 | 93.7 | 94.3 |
| Plus | | | | |
| Check | 0 | 0 | 0 | 0 |

DAST = Days after second treatment

### EXAMPLE 3

### Efficacy Test of Carfentrazone-ethyl on Unwanted Plum Tree Ground Shoots

Trials were conducted by spraying 12-27 g/hl of carfentrazone formulated as a 60 ME (equivalent to 0.2-0.45 l/hl of SPOTLIGHT PLUS 60 ME containing 60 g/l carfentrazone) onto the plum tree ground shoots. The plum trees were evaluated periodically after application. Percent (%) control or efficacy was determined as a percentage by volume reduction of the ground shoots after spraying compared to an untreated reference. Three trials were conducted.

The results, shown as an average of the three trials, are compared with results observed in the same trials with gluphosinate (Basta F1) applied at 1.25 litre/hl. The results and comparison are in Table 3 below.

TABLE 3

% Efficacy

| | Rate | DAT | DAT | DAT | DAT |
|---|---|---|---|---|---|
| | l/hl | 12 | 22 | 47 | 57 |
| Spotlight Plus | 0.2 | 87 | 87 | 92 | 85 |
| 60ME | | | | | |
| Spotlight Plus | 0.3 | 98 | 98 | 95 | 92 |
| 60ME | | | | | |
| Spotlight Plus | 0.45 | 100 | 100 | 100 | 100 |
| 60ME | | | | | |
| Basta F1 | 1.25 | 63 | 85 | 83 | 82 |
| Check | 0 | 0 | 0 | 0 | 0 |

DAT = Days after treatment

### EXAMPLE 4

### Efficacy Test of Carfentrazone-ethyl on Unwanted Plum Tree Ground Shoots

Trials were conducted by spraying 12-27 g/hl of carfentrazone formulated as a 60 ME (equivalent to 0.2-0.45 l/hl of SPOTLIGHT PLUS 60 ME containing 60 g/l carfentrazone) onto the plum tree ground shoots. The plum trees were evaluated periodically after application. Percent (%) control or efficacy was determined as a percentage by volume reduction of the ground shoots after spraying compared to an untreated reference. Three trials were conducted.

The results, shown as an average of the three trials, are compared with results observed in the same trials with gluphosinate (Basta F1) applied at 1.25 litre/hl. The results and comparison are in Table 4 below.

TABLE 4

% Efficacy

| | Rate | DAT | DAT | DAT | DAT |
|---|---|---|---|---|---|
| | l/hl | 16 | 25 | 33 | 46 |
| Spotlight Plus | 0.2 | 75 | 83 | 78 | 82 |
| 60ME | | | | | |
| Spotlight Plus | 0.3 | 93 | 98 | 93 | 92 |
| 60ME | | | | | |
| Spotlight Plus | 0.45 | 97 | 100 | 97 | 93 |
| 60ME | | | | | |
| Basta F1 | 1.25 | 63 | 77 | 75 | 77 |
| Check | 0 | 0 | 0 | 0 | 0 |

DAT = Days after treatment

While this invention has been described with an emphasis upon preferred embodiments, it will be understood by those of ordinary skill in the art that variations of the preferred embodiments may be used and that it is intended that the invention may be practiced otherwise than as specifically described herein. Accordingly, this invention includes all modifications encompassed within the spirit and scope of the invention as defined by the following claims.

What is claimed is:

1. A method for controlling unwanted ground shoots of vines and other trunk vegetation, which comprises applying an effective amount of a protoporphyrinogen oxidase enzyme-inhibiting herbicide to a locus where said ground shoots are growing.

2. The method of claim 1, wherein said unwanted ground shoots of vines and other trunk vegetation are vine ground shoots.

3. The method of claim 1, wherein said unwanted ground shoots of vines and other trunk vegetation are stone fruit tree ground shoots.

4. The method of claim 3, wherein said stone fruit tree ground shoots are plum tree ground shoots.

5. The method of claim 1, wherein said protoporphyrinogen oxidase enzyme-inhibiting herbicide is selected from the group consisting of acifluorfen-sodium, aclonifen, bifenox, chlomethoxyfen, chlornitrofen, ethoxyfen-ethyl, fluorodifen, fluoroglycofen-ethyl, fluoronitrofen, fomesafen, furyloxyfen, halosafen, lactofen, nitrofen, nitrofluorfen, oxyfluorofen, cinidon-ethyl, flumiclorac-pentyl, flumioxazin, profluazol, pyrazogyl, oxadiargyl, oxadiazon, pentoxazone, fluazolate, pyraflufen-ethyl, benzfendizone, butafenacil, fluthiacet-methyl, thidiazimin, azafenidin, carfentrazone ethyl, sulfentrazone, flufenpyr-ethyl, their agriculturally-acceptable salts, esters, acids, and metabolites.

6. The method of claim 5, wherein said protoporphyrinogen oxidase enzyme-inhibiting herbicide is selected from the group consisting of carfentrazone ethyl and metabolites of carfentrazone ethyl, wherein said metabolites are i) α,2-dichloro-5-[4-(difluoromethyl)-4,5-dihydro-3-methyl-5-oxo-1H-1,2,4-triazol-1-yl]-4-fluorobenzenepropanoic acid, ii) 2-dichloro-5-[4-(difluoromethyl)-4,5-dihydro-3-methyl-5-oxo-1H-1,2,4-triazol-1-yl]-4-fluorobenzenepropenoic acid, iii) 2-dichloro-5-[4-(difluoromethyl)-4,5-dihydro-3-methyl-5-oxo-1H-1,2,4-triazol-1-yl]-4-fluorobenzoic acid, and iv) 2-chloro-5-[4-(difluoromethyl)-4,5-dihydro-3-methyl-5-oxo-1H-1,2,4-triazol-1-yl]-4-fluorobenzenepropanoic acid.

7. The method of claim 6, wherein said protoporphyrinogen oxidase enzyme-inhibiting herbicide is carfentrazone ethyl.

8. The method of claim 7, wherein said carfentrazone ethyl is used at a concentration of from about 12 g/hl to about 36 g/hl.

9. The method of claim 8, wherein said carfentrazone ethyl is used at a concentration of about 18 g/hl.

10. The method of claim 1, wherein said protoporphyrinogen oxidase enzyme-inhibiting herbicide is combined with a second herbicide.

11. The method of claim 10, wherein said second herbicide is selected from the group consisting of diquat, paraquat, copper sulfate, copper chelates, endothall, 2,4-D, fluridone, glufosinate-ammonium, glyphosate, imazapyr, fluridone, triclopyr, clomazone and bensulfuron.

12. The method of claim 10, wherein said protoporphyrinogen oxidase enzyme-inhibiting herbicide is carfentrazone ethyl.
